(19) United States
(12) Patent Application Publication
(10) Pub. No.: US 2003/0207626 A1
(43) Pub. Date: Nov. 6, 2003

(54) Terminal bar and terminals for electric devices, and terminal processing method

(76) Inventor: Min-Chen Chang, Taichung Hsien (TW)

Correspondence Address: Hart, Baxley, Daniels & Holton, Fifth Floor, 59 John Street, New York, NY, 10038, US

(21) Appl. No.: 10/137,837

(22) Filed: May 3, 2002

(51) Int. Cl. H01R 4/10

(52) U.S. Cl. 439/877

(57) ABSTRACT

A terminal having a plug portion, and a wire clamp portion eccentrically connected to one end of the plug portion, the plug portion having two wide sides and two narrow sides, the wire clamp portion defining a mouth extended in direction same as one of the narrow side of the plug portion.

### BACKGROUND OF THE INVENTION

1. Field of the Invention

The present invention relates to terminals for electric devices, for example, electric plugs and electric sockets and, more particularly to an improvement on the wire clamp portion of a terminal.

2. Description of the Related Art

FIG. 1 shows a terminal bar according to the prior art. According to this design, a connecting strip connects a plurality of terminals in parallel. Each terminal has a plug portion and a wire clamp portion. The connecting strip extends across the connection areas between the plug portions and the wire clamp portions. The plug portion has two wide sides disposed in horizontal, and two narrow sides disposed in vertical. The wire clamp portion has a substantially U-shaped profile, defining a vertically upwardly extended mouth. The terminals are cut from the connecting strips and arranged in pair, and then respectively installed in terminal holder blocks (see FIG. 2). When a pair of terminals installed in a terminal holder block, the wide sides of the plug portions are disposed in vertical, the narrow sides of the plug portions are disposed in horizontal, and the U-shaped wire clamp portions are disposed in horizontal and facing each other. According to this design, the operator cannot fasten the electric wires (conductors) of the power cord to the wire clamp portions at one time, i.e., the electric wires (conductors) of the power cord must be separately fastened to the wire clamp portions of the two terminals in the terminal holder block. In order to eliminate this drawback, the plug portion of each terminal is twisted through 90° from horizontal to vertical before installation in a terminal holder block (see FIGS. 3 and 4). However, this plug portion twisting procedure complicates the fabrication of the electric device. Further, in the aforesaid design, the plug portion and the wire clamp portion are longitudinally aligned. When installed in a terminal holder block, the pitch between positive and negative terminals is equal to the pitch between the wire clamp portions of the terminals. To fit different pitches, different wire crimping tools are required to process the wire clamp portions. The use of different wire crimping tools greatly increases terminal manufacturing cost.

### SUMMARY OF THE INVENTION

The present invention has been accomplished under the circumstances in view. It is one object of the present invention to provide a terminal, which facilitates the adjustment of the pitch between terminals upon installation of terminals in a terminal holder block. It is another object of the present invention to provide a terminal, which facilitates installation in a terminal block. To achieve these and other objects and according to one aspect of the present invention, the terminal comprises a plug portion; and a wire clamp portion eccentrically connected to one end of the plug portion, the wire clamp portion defining an upwardly extended mouth. According to another aspect of the present invention, the plug portion has two wide sides and two narrow sides, and the mouth of the wire clamp portion extends in direction same as one narrow side of the plug portion.

### BRIEF DESCRIPTION OF THE DRAWINGS

FIG. 1 is a perspective view of a terminal bar according to the prior art.

FIG. 2 illustrates installation of the prior art terminals of FIG. 1 in a terminal holder block.

FIG. 3 is a schematic drawing showing the plug portion twisted from horizontal to vertical according to the prior art.

FIG. 4 illustrates installation of the prior art terminal of FIG. 3 in a terminal holder block.

FIG. 5 is a perspective view of a terminal bar according to one embodiment of the present invention.

FIG. 6 is similar to FIG. 5 but showing the wire clamp portions curved.

FIG. 7 is a perspective view of a terminal bar according to a second embodiment of the present invention.

FIG. 8 is similar to FIG. 7 but showing the wire clamp portions curved.

FIG. 9 shows a pair of terminals installed in a terminal holder block according to one application example of the present invention.

FIG. 10 is a rear side view of FIG. 9.

FIG. 11 shows a pair of terminals installed in a terminal holder block according to another application example of the present invention.

FIG. 12 is a rear side view of FIG. 11.

FIG. 13 is a rear side view of still another application example of the present invention.

FIG. 14 is a rear side view of still another application example of the present invention.

FIG. 15 is a perspective view of still another application example of the present invention.

FIG. 16 is a perspective view of still another application example of the present invention.

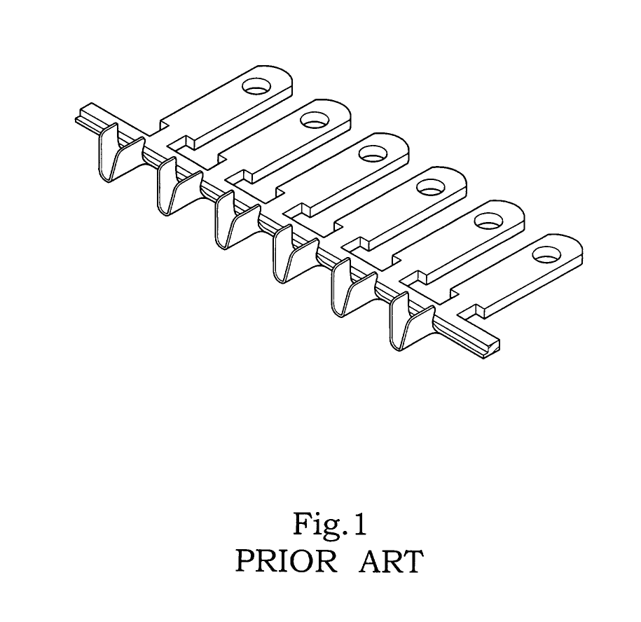

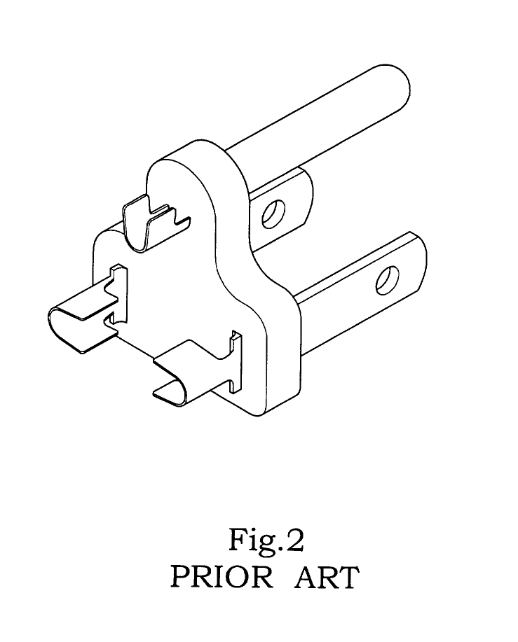

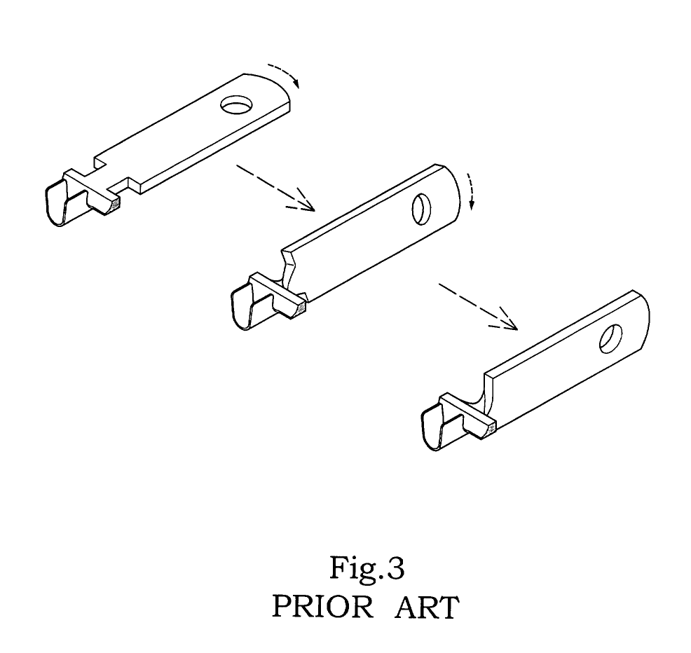

### DETAILED DESCRIPTION OF THE PREFERRED EMBODIMENT

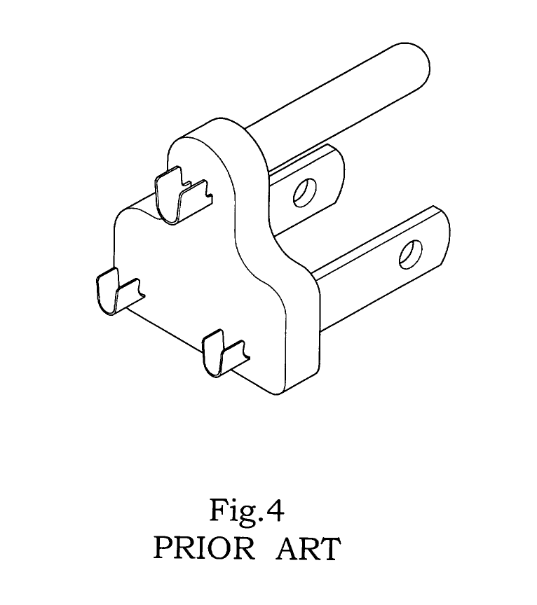

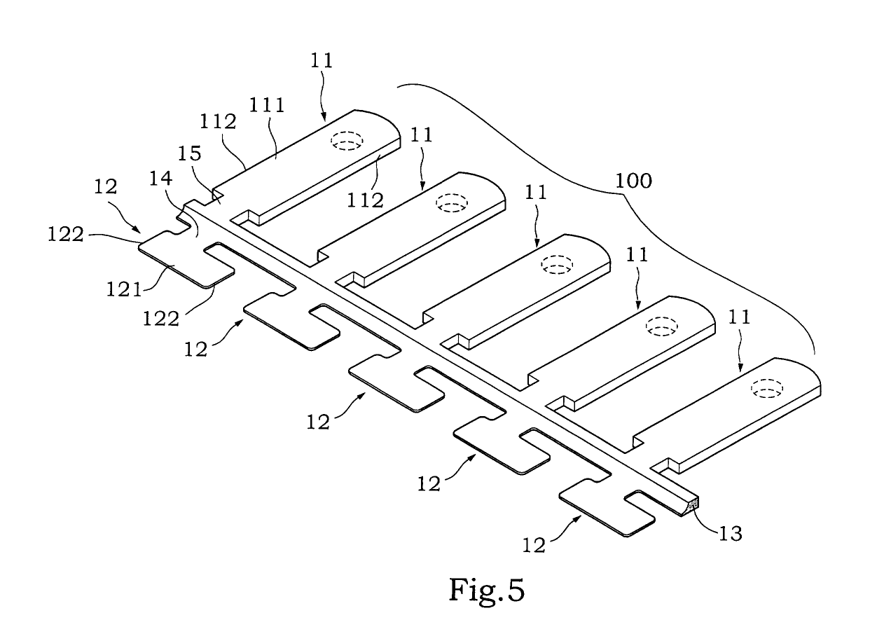

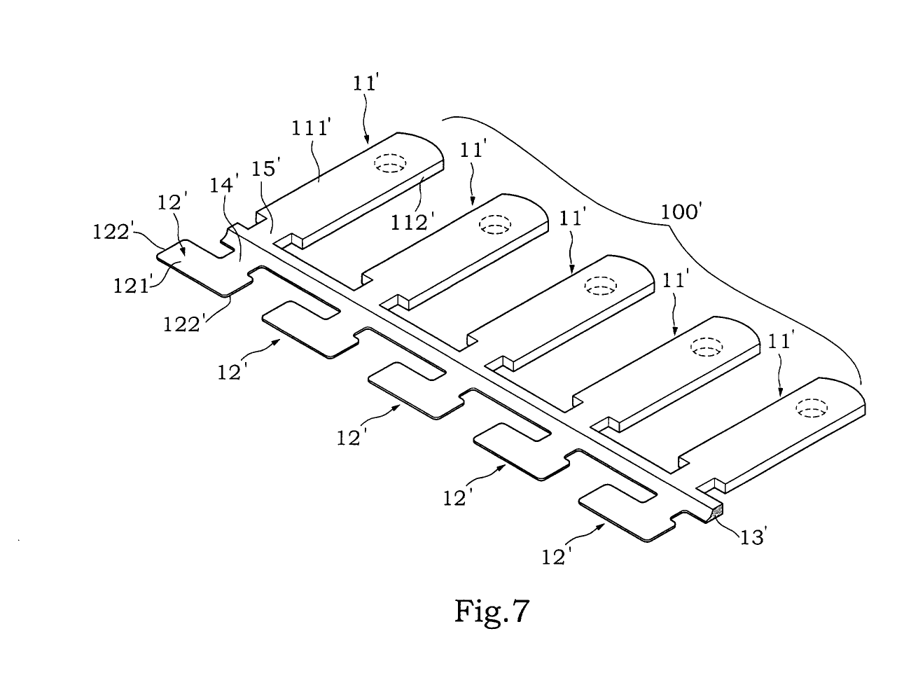

Referring to FIGS. 5 and 7 a terminal for electric device in accordance with the present invention is shown comprising a plug portion 11 or 11′ and a wire clamp portion 12 or 12′. For continuous material feeding, a connecting strip 13 or 13′ joins plug portions 11;11′ and wire clamp portions 12;12′, forming a terminal bar 100 or 100′. The plug portion 11 or 11′ of each terminal of the terminal bar 100 or 100′ has the respective wide sides 111 or 111′ disposed in horizontal and the respective narrow sides 112 or 112′ disposed in vertical. The wire clamp portion 12 or 12′ of each terminal of the terminal bar 100 or 100′ is extended out, having the wide sides 121 or 121′ disposed in horizontal and the narrow sides 122 or 122′ disposed in vertical. The wire clamp portion 12 or 12′ has a neck 14 or 14′ connected to the connecting strip 13 or 13′. The plug portion 11 or 11′ has a neck 15 or 15′ connected to the connecting strip 13 or 13′. The neck 14 or 14′ of the wire clamp portion 12 or 12′ and the neck 15 or 15′ of the corresponding plug portion 11 or 11′ are not longitudinally aligned in a line, i.e., neck 14 or 14′ of the wire clamp portion 12 or 12′ is disposed eccentric to the neck 15 or 15′ of the corresponding plug portion 11 or 11′. The wire clamp portion 12 or 12′ is eccentrically connected to the respective neck 14 or 14′. Therefore, the wire clamp portion 12 or 12; has a narrow left (or right) lateral section and broad right (or left) lateral section. The terminal bars 100;100′ shown in FIGS. 5 and 7 have the respective wire clamp portions 12′12′ eccentrically biased in reversed directions.

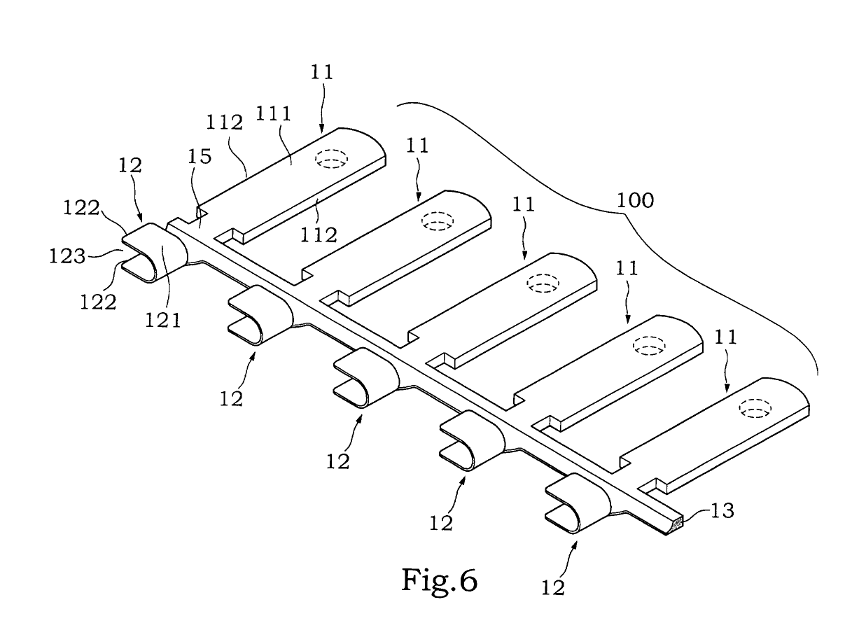

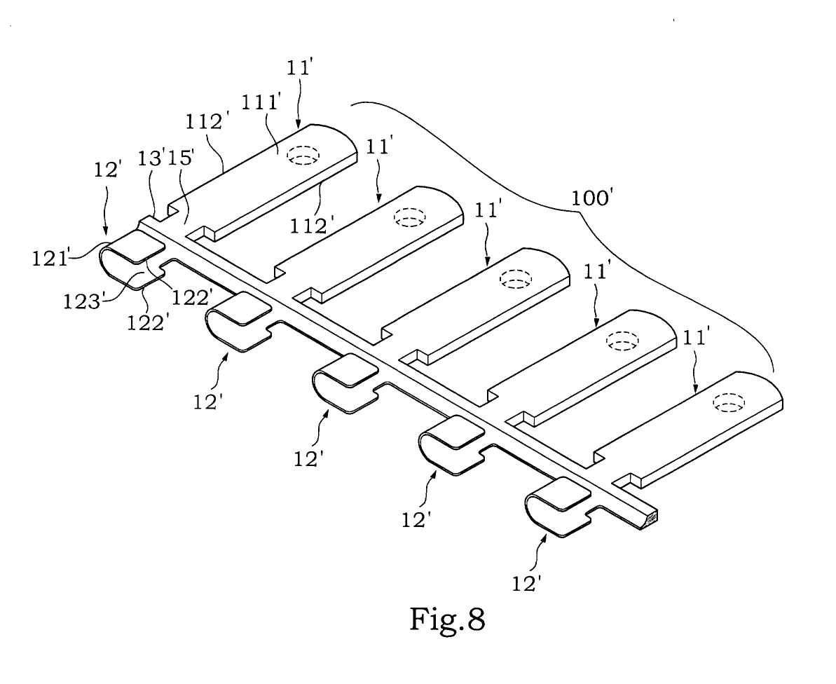

Referring to FIGS. 6 and 8, the broad right (or left) lateral section of the wire clamp portion 12 or 12′ is curved inwards, defining with the corresponding narrow left (or right) lateral section a mouth 123 or 123′. The mouth 123 or 123′ extends in same direction as one narrow side 112 or 112′ of the plug portion 11. The terminal bars 100;100′ shown in FIGS. 6 and 8 have the mouths 123;123′ reversed.

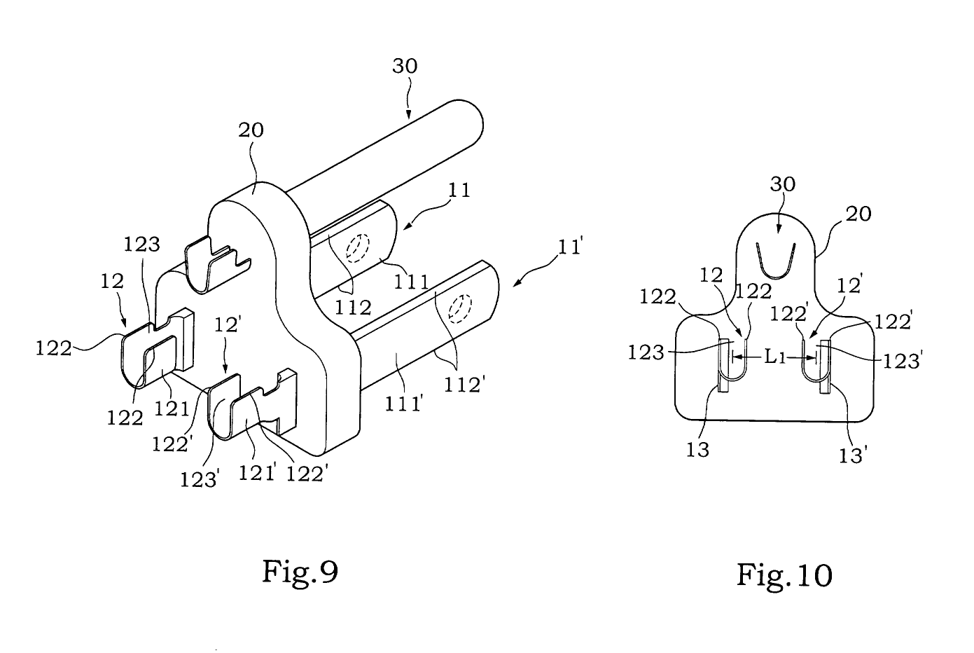

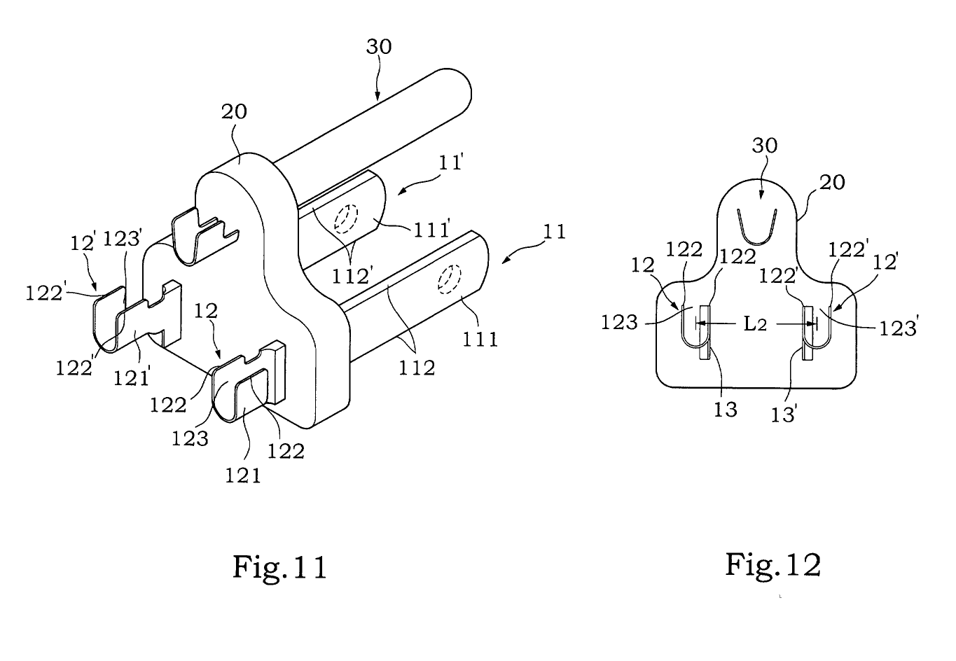

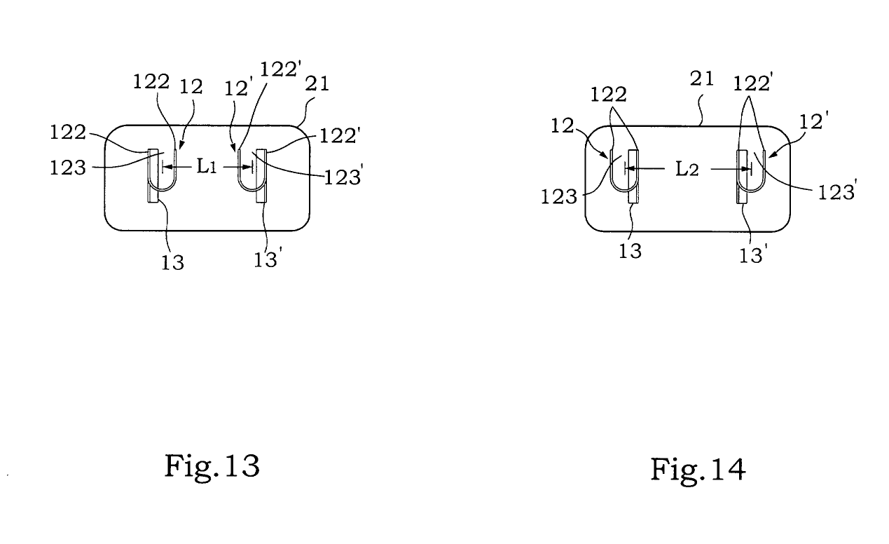

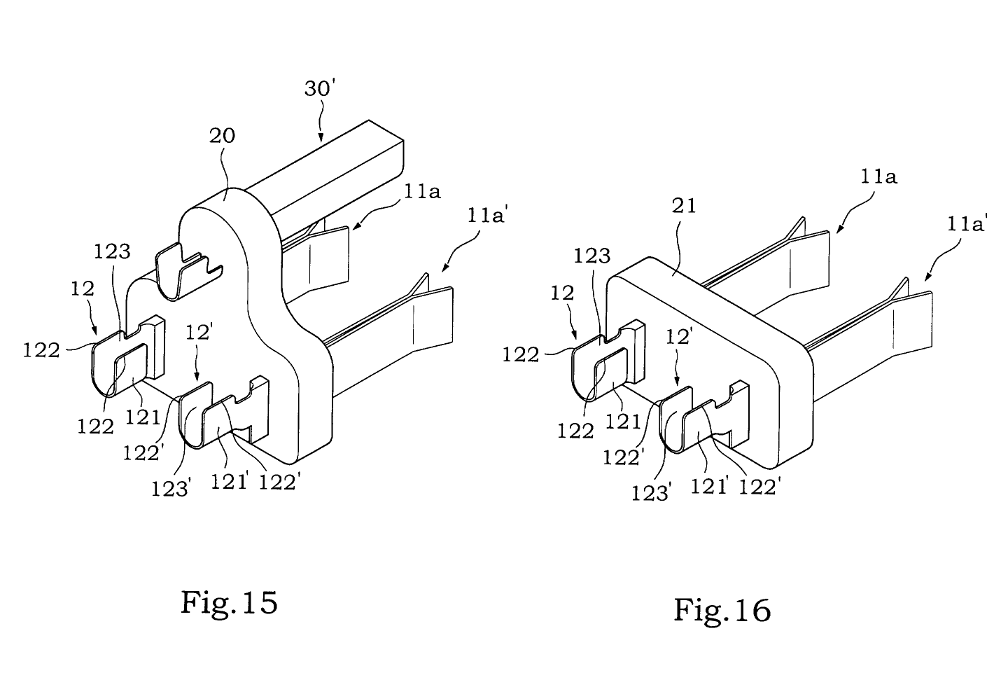

The connecting strip 13 or 13′ of each terminal bar 100 or 100′ is proper cut, separating the terminal bar 100 or 100′ into multiple independent terminals that are then arranged in pair and respectively installed in terminal holder blocks 20 for an electric device (see FIGS. 9 and 11). When a pair of terminals installed in a terminal holder block 20, the wire clamp portions 12;12′ are crimped by crimping means to secure the respective electric wire of the power cord.

After installed in a terminal holder block 20, the wide sides 111 or 111′ of the plug portions 11 or 11′ of each terminal are changed from the horizontal position to the vertical position; the narrow sides 112;112′ of plug portions 11 or 11′ of each terminal are changed from the horizontal position to the vertical position. Because the mouth 123 or 123′ extends in same direction as one narrow side 112 or 112′ of the plug portion 11, it extends upwards when the narrow side 112 or 112′ changed from the horizontal position to the vertical position. At this time, the wire clamp eccentrically connected to its plug portion 11 or 11′, keeping the mouth 123 or 123′ in direction same as one narrow side 112 or 112′ of the plug portion 11 or 11′. The mouths 123;123′ of the matched pair of terminals are disposed upwards for clamping electric wires after installation of the matched pair of terminals in the terminal holder block 20 or 21.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. Terminals for electric device each comprising:
a plug portion; and
a wire clamp portion eccentrically connected to one end of said plug portion, said wire clamp portion defining an upwardly extended mouth.

2. The terminals as claimed in claim 1, wherein said plug portion has two wide sides and two narrow sides.

3. The terminals as claimed in claim 2, wherein the mouth of said wire clamp portion extends in direction same as one of the narrow sides of said plug portion.

4. The terminals as claimed in claim 2, wherein the narrow sides of said plug portion are disposed in vertical and the wide sides of said plug portion are disposed in horizontal when the terminals arranged in pair and installed in a respective terminal holder block, keeping the mouth of said wire clamp portion extended vertically upwards.

5. The terminal as claimed in claim 4, wherein the wire clamp portions of each pair of terminals are eccentrically disposed at an inner side relative to the terminals after installation of each pair of terminals in a respective terminal holder block.

6. The terminal as claimed in claim 4, wherein the wire clamp portions of each pair of terminals are eccentrically disposed plug portions each have two wide sides disposed in vertical and two narrow sides disposed in horizontal.

12. The terminal bar as claimed in claim 10, wherein said wire clamp portions each have two wide sides disposed in vertical and two narrow sides disposed in horizontal.

13. The terminal bar as claimed in claim 10, wherein said wire clamp portions each have a neck connected to said connecting strip and disposed eccentric to the corresponding plug portion.

14. The terminal bar as claimed in claim 13, wherein said wire clamp portions are eccentrically connected to the respective necks, each having a narrow lateral section and broad lateral section relative to the respective neck.

15. The terminal bar as claimed in claim 14, wherein the broad lateral section of each of said wire clamp portions is respectively curved inwards, defining with the respective narrow lateral section a mouth.

16. A terminal processing method including the step of stamping a metal plate member into a plug portion and a wire clamp portion extended from one end of said plug portion, and the step of bending said wire clamp portion into a curved shape eccentric to said plug portion and defining a mouth.

17. The terminal processing method as claimed in claim 16, wherein said wire clamp portion is eccentrically connected to said plug portion, having a narrow lateral section and broad lateral section.

18. The terminal processing method as claimed in claim 17, wherein said broad lateral section is bent inwards toward said narrow lateral section during the step of bending said wire clamp portion into a curved shape eccentric to said plug portion.
